(19) United States
(12) Patent Application Publication
(10) Pub. No.: US 2015/0046227 A1
(43) Pub. Date: Feb. 12, 2015

(54) INVENTORY DEPLOYMENT OPTIMIZATION APPARATUS AND METHOD

(71) Applicant: Wal-Mart Stores, Inc., Bentonville, AR (US)

(72) Inventors: Arash Asadi, Brisbane, CA (US); Rishabh Kothari, Brisbane, CA (US); Jagtej Bewli, Brisbane, CA (US)

(73) Assignee: Wal-Mart Stores, Inc., Bentonville, AR (US)

(21) Appl. No.: 13/964,855

(22) Filed: Aug. 12, 2013

(51) Int. Cl. G06Q 10/06; G06Q 10/08

(52) U.S. Cl. CPC G06Q 10/0637; G06Q 10/087
USPC 705/7.36

(57) ABSTRACT

A computer-implemented method is disclosed for optimizing a flow network. In the method, a computer system may obtain first data characterizing supply sites, demand sites, and lanes of a distribution network. The computing system may also obtain second data characterizing supply and demand for an item distributed within the distribution network. Using the first and second data, a computer system may determine a maximum possible flow of the item within the distribution network. Subsequently, the computer system may use the maximum possible flow as a benchmark in determining which lanes of the distribution network are required to achieve the maximum possible flow and which lanes of the distribution network are redundant lanes. From among a remaining set of required, non-redundant lanes, a computer system may select a lowest cost solution for achieving the maximum possible flow.

### BACKGROUND

1. Field of the Invention

This invention relates to computerized optimization and more particularly to systems and methods for optimizing the transfer of items from a plurality of parent or supply sites to a plurality of child or demand sites.

2. Background of the Invention

A distribution network may be defined as an entire chain of distribution intermediaries that extends from a supplier to an end consumer. It has been said that a strong and efficient distribution network is one of the most important assets a manufacturer or retailer can have. Accordingly, what is needed is a system and method for improving the efficiency of a distribution network.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic diagram of a simplified, sample network in accordance with the present invention;

FIG. 2 is a schematic block diagram of one embodiment of a computer system in accordance with the present invention;

FIG. 3 is a schematic block diagram of one embodiment of an optimization module in accordance with the present invention;

FIG. 4 is a schematic block diagram of one embodiment of an optimization method in accordance with the present invention;

FIG. 5 is a schematic block diagram of one embodiment of a method for determining a maximum possible flow while respecting proportionality in accordance with the present invention;

FIG. 6 is a schematic block diagram of one embodiment of a method for identifying required lanes within a network in accordance with the present invention; and

FIG. 7 is a schematic block diagram of one embodiment of a method for identifying and/or eliminating redundant lanes within a network in accordance with the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

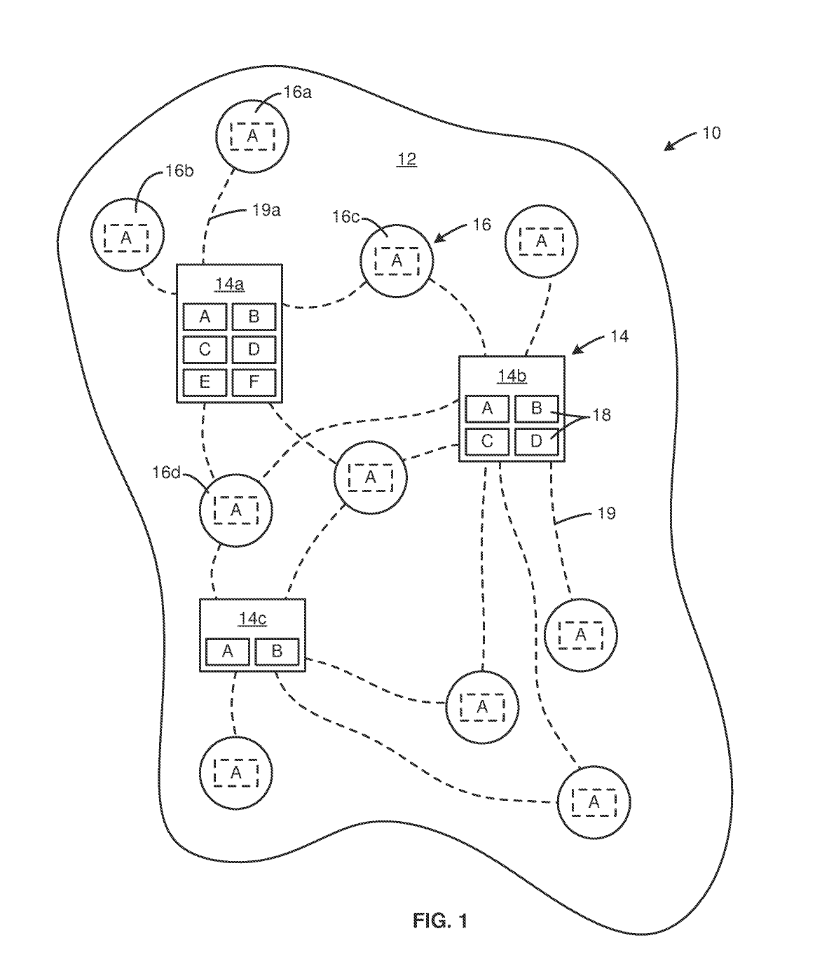

Referring to FIG. 1, a network 10 in accordance with the present invention may occupy or extend across a domain 12. Located within such a domain 12 may be a collection of discrete parent or supply sites 14 and child or demand sites 16. As a network operates, one or more items 18 may travel along various lanes 19 or paths 19 between such sites 14, 16. For example, each parent site 14 may have one or more items 18 to supply, while each child site 16 may need one or more items 18. Accordingly, one or more items 18 may travel on lanes 19 from one or more parent sites 14 to one or more child sites 16.

Regardless of the type of network at issue, a network 10 in accordance with the present invention may benefit from some form of optimization. For example, a network 10 may be or comprise a computer-based information network 10. Alternatively, a network 10 may be or comprise a wholesale or retail distribution network 10. In either embodiment, the operation of a network 10 may be optimized to improve efficiency, lower cost, or the like.

For example, in certain embodiments, a network 10 may be or comprise a distribution network 10 for tangible goods (e.g., one or more discreet items 18 offered for sale). In such embodiments, a domain 12 may be a geographic region such as a state, nation, region, continent, or the like or a combination or sub-combination thereof. Each parent site 14 may be a parent warehouse (e.g., an import distribution center (IDC), regional distribution center (RDC), high velocity distribution center (HVDC), or the like). Each child site 14 may be a store, child warehouse (e.g., an e-commerce distribution center (eDC)), or the like. Through optimization in accordance with the present invention, transportation costs, time-in-transit, resource allocation, or the like for such a network 10 may be improved.

A distribution network 10 may have various features, characteristics, or needs that complicate an optimization process. For example, in certain networks 10, lanes 19 may exist between a small set of parent and child sites 14, 16. Accordingly, one parent site 14 cannot directly supply all child sites 16. Other complicating factors may include limitations in the quantities of a particular item 18 stored in a particular parent site 14, limitations in the storage space available at one or more parent sites 14, limitations in which parent sites 14 stock which items 18, or the like.

For example, in the simplified exemplary network 10 of FIG. 1, a snapshot in time corresponding to one item 18 (i.e., “Item A”) is illustrated. Each of the three parent sites 14a, 14b, and 14c illustrated stock at least some quantity of Item A. Each of the child sites 16 illustrated need at least some quantity of Item A. However, lanes 19 (e.g., shipping channels, contracts, schedules, or the like) do not connected every child site 16 to every parent site 14. For example, certain child sites 16a, 16b can only receive Item A from a certain parent site 14a. Other child sites 16c can receive Item A from two of the parent sites 14a, 14b. Still other child sites 16d can receive Item A from any of the three parent sites 14a, 14b, 14c.

Through an optimization system and method in accordance with the present invention, it may be determined how much of Item A should be supplied to which child sites 16 from which parent sites 14. In selected embodiments, an optimization system and method may identify required lanes 19, eliminate redundant lanes 19, and select the most cost effective lanes 19.

A required lane 19 may be a lane 19 that must be used if a maximum flow through a network 10 is to be achieved. For example, a first lane 19a may connect a first parent site 14a to a first child site 16a. In the simplified exemplary network 10 of FIG. 1, the first lane 19a may be the only through which the first child site 16a can receive Item A. However, the first lane 19a may or may not be a required lane 19. That is, if there is a shortage of Item A within the network 10, it may be more efficient (e.g., produce a greater overall flow) to leave the needs of the first child site 16a unmet in order to meet more of the needs of other child sites 16.

In selected embodiments, a redundant lane 19 may be a non-required lane 19 that is more difficult to discover (e.g., cannot be discovered by a single lane removal method in accordance with the present invention). Accordingly, once any redundant lanes 19 have been identified and eliminated, a core set of required lanes 19 may be identified.

Within this core set may be one or more alternatives. For example, different distributions schemes may use different lanes 19, but produce the same total flow within the network 10. Accordingly, a choice must be made as to which alternative or scheme to follow. In selected embodiments, an optimization system and method in accordance with the present invention may select the alternative or scheme that has the lowest cost (e.g., least expensive lanes 19) associated therewithin. Thus, an optimization system and method may identify, select, implement, or the like the least costly plan for achieving maximum flow within a network 10.

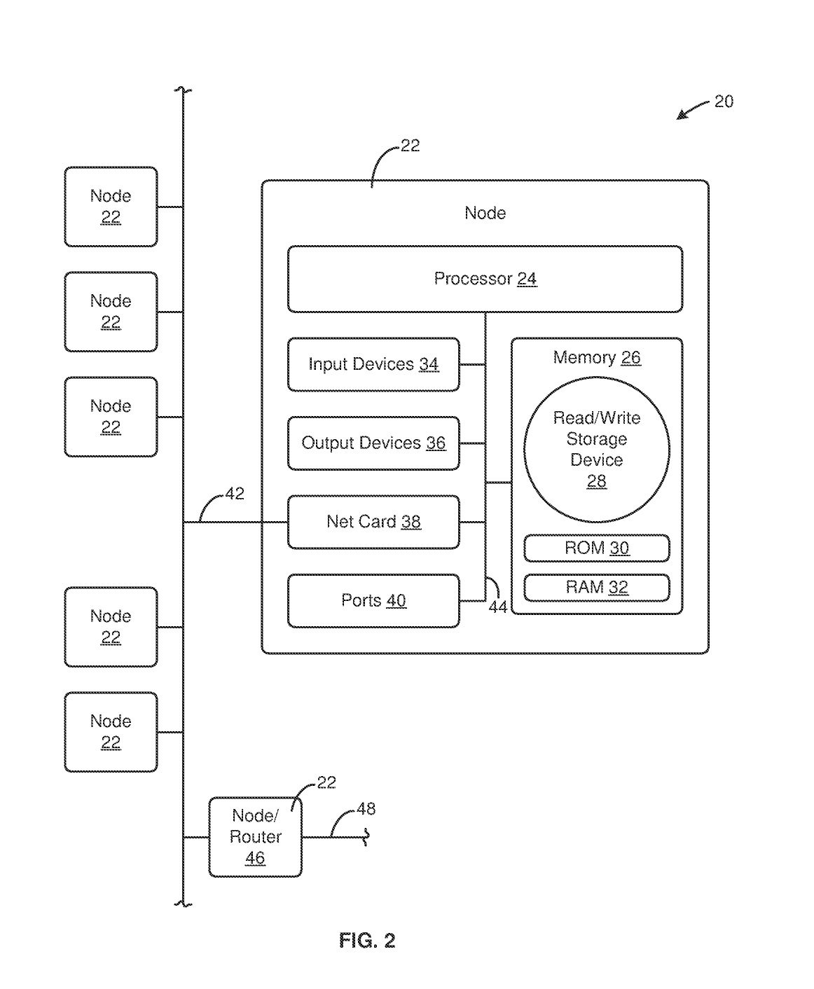

Referring to FIG. 2, in selected embodiments, a computer system 20 may perform the steps, computations, comparisons, logic, or the like necessary to optimize the operation of a network 10. A computer system 20 in accordance with the present invention may provide, enable, or support network optimization in any suitable manner. In certain embodiments, a system 20 may be embodied as hardware, software, or some combination thereof. For example, in selected embodiments, a system 20 may include one or more nodes 22.

A node 22 may include one or more processors 24, processor cores 24, or central processing units (CPUs) 24 (hereinafter “processors 24”). In selected embodiments, a node 22 may include memory 26. Such memory 26 may be operably connected to a processor 24 and include one or more devices such as a hard drive 28 or other non-volatile storage device 28, read-only memory (ROM) 30, random access memory (RAM) 32, or the like or a combination or sub-combination thereof. In selected embodiments, such components 24, 26, 28, 30, 32 may exist in a single node 22. Alternatively, such components 24, 26, 28, 30, 32 may be distributed across multiple nodes 22.

In selected embodiments, a node 22 may include one or more input devices 34 such as a keyboard, mouse, touch screen, scanner, memory device, communication line, and the like. A node 22 may also include one or more output devices 36 such as a monitor, output screen, printer, memory device, and the like. A node 22 may include a network card 38, port 40, or the like to facilitate communication through a computer network 42. Internally, one or more busses 44 may operably interconnect various components 24, 26, 34, 36, 38, 40 of a node 22 to provide communication therebetween. In certain embodiments, various nodes 22 of a system 10 may contain more or less of the components 24, 26, 34, 36, 38, 40, 44 described hereinabove.

Different nodes 22 within a system 20 may perform difference functions. For example, in selected embodiments, one node 22 within a system 20 may perform or conduct an optimization method in accordance with the present invention. Alternatively, one or more nodes 22 within a system 22 may function as or be master nodes 22. Additionally, one or more nodes 22 within a system 20 may function as or be worker nodes 22. Accordingly, a system 20 may include one or more master nodes 22 distributing work to one or more worker nodes 22. In selected embodiments, a system 20 may also include one or more nodes 22 that function as or are routers 46 and the like. Accordingly, one computer network 42 may be connected to other computer networks 48 via one or more routers 46.

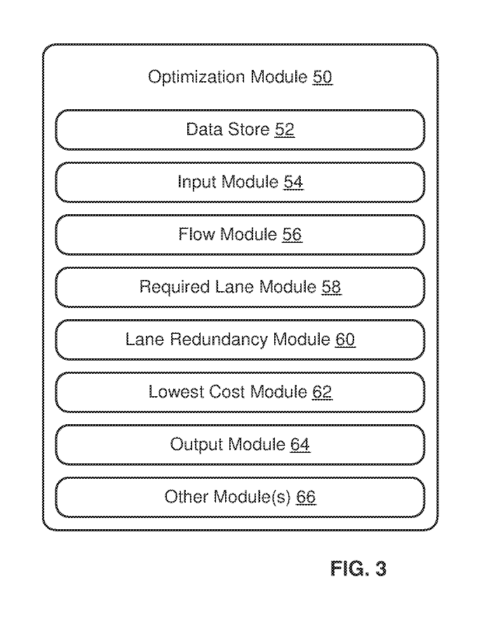

Referring to FIG. 3, a system 20 in accordance with the present invention may perform or conduct an optimization method in any suitable manner. In selected embodiments, the nature of the hardware and/or software of a system 20 may reflect the specific process to be performed. For example, a system 20 configured to optimize the operation of a network 10 may include an optimization module 50 providing, enabling, or supporting such functionality.

An optimization module 50 in accordance with the present invention may include any suitable arrangement of sub-components or modules. In certain embodiments, an optimization module 50 may include a data store 52, input module 54, flow module 56, required lane module 58, lane redundancy module 60, lowest cost module 62, output module 64, one or more other modules 66 as desired or necessary, or the like or a combination or sub-combination thereof.

A data store 52 may contain or store any information that may be used or needed by an optimization module 50 or one or more components thereof. In selected embodiments, a data store 52 may contain or store information corresponding to one or more patent sites 14, child sites 16, items 18, lanes 19, or the like or combinations or sub-combinations thereof. For example, a data store 52 may contain information regarding the stock of selected items 18, storage capacity, or the like corresponding to one or more parent sites 14. A data store 52 may contain information identifying how many of selected items 18 are needed by one or more child sites 16. A data store 52 may also contain information identifying origins, destinations, costs, capacities, travel times (e.g., time-in-transit), or the like of one or more lanes 19. Thus, a data store 52 may store sufficient information describing or defining a network 10 for an optimization module 50 to model that network 10.

An input module 54 may generate, collect, extract, receive, communicate, and/or process any inputs (e.g., instructions, information, etc.) needed or used by an optimization module 50 or one or more components thereof. For example, an input module 54 may receive a command or instruction to begin an optimization process. Alternatively, or in addition thereto, an input module 54 may collect, receive, extract, or communicate information or records that may be used or processed by one or more other components or modules of an optimization module 50.

A flow module 56 may quantify the efficiency that may potentially be achieved for a given network 10. A flow module 56 may accomplish this in any suitable manner. In selected embodiments, a flow module 56 may calculate a maximum flow through a network 10. For example, a flow module 56 may apply or use a Ford-Fulkerson algorithm to calculate maximum flow.

A required lane module 58 may identify required lanes 19 within a network 10. A required lane module 58 may accomplish this in any suitable manner. In selected embodiments, a required lane module 58 may serially remove one lane 19 at a time from a model of a network 10. Once a lane 19 has been removed, a required lane module 58 may cooperate with a flow module 56 to determine a maximum flow for the now modified network 10. By comparing a maximum possible flow for the network 10 with a maximum flow for the modified network 10, a required lane module 58 may determine whether the removed lane 19 is required.

A lane redundancy module 60 may identify redundant lanes 19 within a network 10. A lane redundancy module 60 may accomplish this in any suitable manner. In selected embodiments, a lane redundancy module 60 may use a depth-first search with different arrangement or collections of lanes 19 in an effort to identify lanes 19 that are redundant and can be eliminated (e.g., not used in a particular situation).

A lowest cost module 62 may identify which lanes 19 (e.g., which of the alternative required lanes 19) should be used to minimize the cost of achieve a particular network flow (e.g., a maximum possible flow). A lowest cost module 62 may accomplish this in any suitable manner. In selected embodiments, a lowest cost module 62 may simply compare the cost of alternative lanes 19 or alternative sets of lanes 19 and identify the one with the lower cost.

In selected embodiments, the cost of a lane 19 may be determined or identified in exclusively financial terms (e.g., the direct financial cost to ship one or more items 18 from a corresponding parent site 14 to a corresponding child site 16). In other embodiments, other considerations or factors may contribute to, or even dominate in, a determination of the cost of a lane 19. For example, in certain situations or applications, time (e.g., travel time, time-in-transit, or the like) may be considered in determining cost.

An output module 64 may generate, collect, compile, send, communicate, and/or process any outputs of an optimization module 50. For example, in selected embodiments, an output module 64 may pass (e.g., to a data store 52 for storage, implementation, or both) information identifying which lanes 19 should be used to pass what quantities of which items 18.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on one node 22. Alternatively, the program code may execute on one or more master nodes 22, worker nodes 22, or combinations thereof. In selected embodiments, one or more master and/or nodes 22 may be positioned remotely with respect to one another. Accordingly, such nodes 22 may be connected to one another through any type of network, including a local area network (LAN) or a wide area network (WAN), or the connection may be made through the Internet using an Internet Service Provider.

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Selected embodiments in accordance with the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

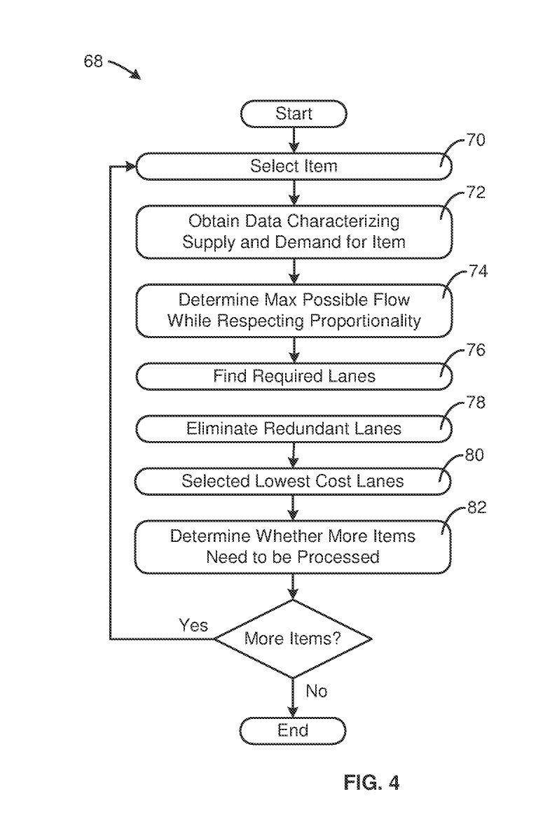

Referring to FIG. 4, in selected embodiments, an optimization method 68 may be conducted on an item-by-item basis. Accordingly, once a particular item 18 has been selected 70 and the data characterizing the supply and demand for that item 18 within a network 10 has been obtained 72, an optimization module 50 (e.g., a flow module 56) may determine 74 a maximum possible flow for the network 10. In certain embodiments, this may be done while respect (e.g., preserving, preserving as much as possible, or the like) the proportionality of demand among the child sites 16.

Once determined 74, a maximum possible flow may be used as a benchmark. In selected embodiments, a maximum possible flow may be used to find 76 certain required lanes 19. For example, as noted above, a required lane module 58 may serially remove one lane 19 at a time from a model of a network 10. Once a lane 19 has been removed, a required lane module 58 may cooperate with a flow module 56 to determine a maximum flow for the now modified network 10. By comparing a maximum possible flow for the network 10 with a maximum flow for the modified network 10, a required lane module 58 may determine whether the removed lane 19 is required. A similar or analogous process may be used to find and eliminate 78 redundant lanes 19.

Once the required lanes 19 have been identified 76 and the redundant lanes 19 eliminated, one or more alternatives or different schemes may still be supported or implemented within a network. Accordingly, there may be a need to decide which alternative to pursued. In selected embodiments, this decision may be based on which alternative is the lowest cost alternative. Thus, in certain embodiments, the lowest cost lanes 19 (e.g., the lanes 19 with the lowest direct financial cost, the lanes 19 with the lowest time-in-transit, or the like or weighted combinations thereof) may be selected 80 and pursued or used.

A determination 82 may then be made as to whether there are more items 18 to process. If there are, another item 18 may be selected 70 and the process may continue. Once all the necessary items 18 have been processed, the optimization process 68 may end. Upon completion of an optimization method 68, an optimization module 50 may have, output, implement, or the like various plans or instructions. For example, an optimization module 50 may output specific instructions such as ship this quantity of Item A from the first parent site 14a to the first child site 16a, ship this quantity of Item B from the first parent site 14a to this child site 16, etc.

In certain embodiments, an optimization method 68 in accordance with the present invention may be executed periodically. The length of that period may depend on the amount of activity within the network 10. In general the more active the network 10, the shorter the period. In selected embodiments in which one or more child sites 16 comprise an eDC fulfilling Internet orders for a national retailer, an optimization method 68 may be executed at least daily.

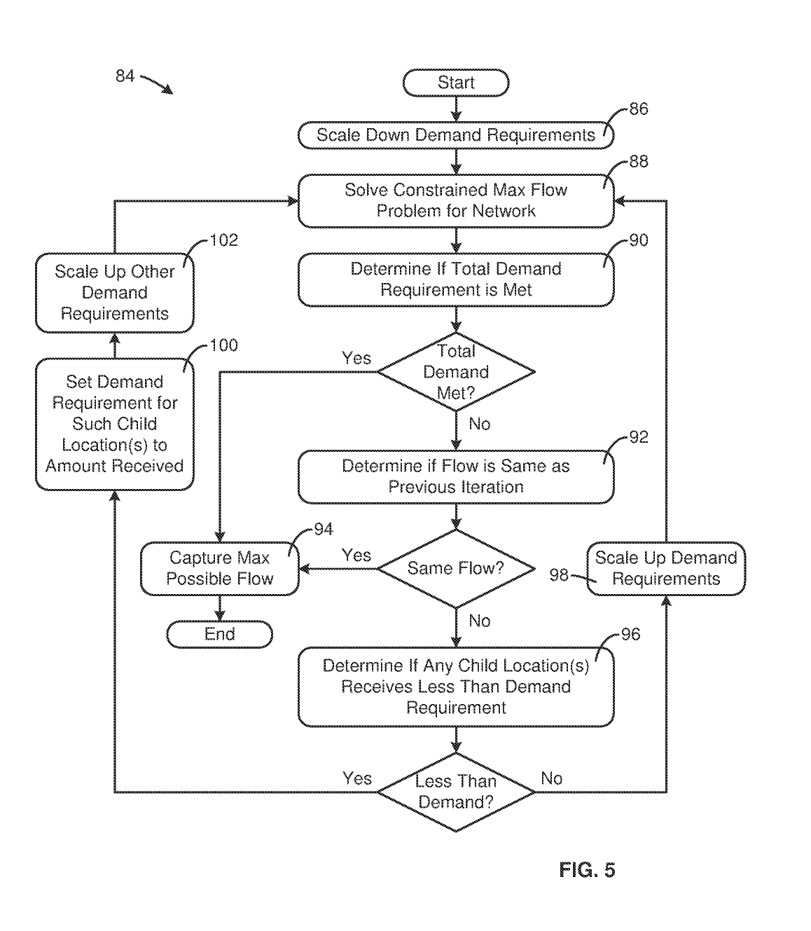

Referring to FIG. 5, in selected embodiments, an optimization module 50 or some component thereof (e.g., a flow module 56) may determine 74 a maximum possible flow for a network 10. This may be done in any suitable manner. In certain embodiments, a maximum possible flow may be determined 74 via a method 84 that respects the proportionality of demand among the child sites 16. Such a method 85 may begin when the demand of the various child sites 16 for an item 18 is scaled 86 down.

The purpose of such scaling 86 may be to lower the localized and collective demand to a level that can be met by the parent sites 14 within the corresponding network 10. Accordingly, the demand for a particular item 18 may be scaled 86 down to any percentage that accomplishes this purpose. Typically, the demand of the various child sites 16 for an item 18 may be scaled 86 down to a percentage in the range from about 1% to about 50% of the original demand. However, a wider variety of networks 10 and network situations may be handled by scaled 86 down to a percentage in the range from about 1% to about 10% of the original demand.

Scaling 86 down the demand requirements of the various child sites 16 may preserve the proportionality of demand among those child sites 16. For example, first, second, and third child sites 16 may respectively report a demand for 150, 460, and 940 units of a particular item 18. If these demand requirements were scaled 86 down to 10%, the result would be a demand for 15, 46, and 94 units, respectively.

Once the demand requirements for the various child sites 16 have been scaled 86 down, an optimization module 50 or some component thereof (e.g., a flow module 56) may solve 88 a constrained maximum flow problem for the corresponding network 10. This may be done or accomplished in any suitable manner. For example, a Ford-Fulkerson algorithm or the like may be used to calculate a maximum flow.

After the constrained maximum flow problem for the network 10 has been solved 88, one or more determinations 90, 92 may be made. These determinations 90, 92 may reflect on whether a suitable stopping point has been reached. For example, one determination 90 may be made as to whether the total demand requirement has been met. If it has, the most recent maximum flow may be captured 94 or designated as the maximum possible flow for the network 10. However, due to the scaling 86 down of the demand requirement, an initial maximum flow will not typically correspond to the total demand requirement for the network 10. Accordingly, in the early stages (e.g., early iterations) of a method 84, the total demand requirement will not be met and the process may continue.

Another determination 90 may be made as to whether the maximum flow just calculated is the same as a maximum flow previously calculated. If it is, this may be an indication that a maximum possible flow has been reached. Accordingly, the recently calculated maximum flow may be captured 94 or designated as the maximum possible flow for the network 10. Again however, due to the scaling 86 down of the demand requirement, the maximum flows initially calculated will not typically plateau. Accordingly, in the early stages (e.g., early iterations) of a method 84, the calculated maximum flow will typically increase with each iteration and the process may continue.

Within a method 84, a determination 96 may be made as to whether any child site 16 has “received” (e.g., been allocated within the computer model) less than a demand requirement corresponding thereto. Such a determination 96 may be a deciding factor in determining what changes are to be made for the next iteration within the method 84. For example, if it is determined 96 that no child site 16 has received less than a demand requirement corresponding thereto, then no bottlenecks within the network 10 have yet been reached. This is an indication that the maximum possible flow has also not been reached. Accordingly, the demand requirements of the various child sites 16 may be scaled 98 up by some acceptable percentage and one or more of the steps within a method 84 may be repeated.

Conversely, if it is determined 96 that one or more child sites 16 have received less than the demand requirements corresponding respectively thereto, then one or more bottlenecks within the network 10 may have been reached. For these one or more child sites 16 further increase in demand may not result in a greater supply being received. Accordingly, the demand requirement for these one or more child sites 16 may be set 100 to the amount received, while the demand requirements corresponding to the remaining child sites 16 may be scaled 102 up by some acceptable percentage. One or more of the steps within a method 84 may then be repeated. In this manner, a maximum possible flow may be captured 94 while the proportional of demand among the various child sites 16 is respected.

The percentage used in scaling 98, 100 up one or more demand requirements may have any suitable value. In selected embodiments, a relatively small percentage step or increase may be suitable. For example, the demand requirements may be scaling 98, 100 up by about one percentage point. Accordingly, if an initial or actual demand of 540 unit were scaled 86 down to 54 units, that demand requirement may be incrementally scaled 98, 100 up to 59.4, 64.8, etc., or whole numbers corresponding thereto.

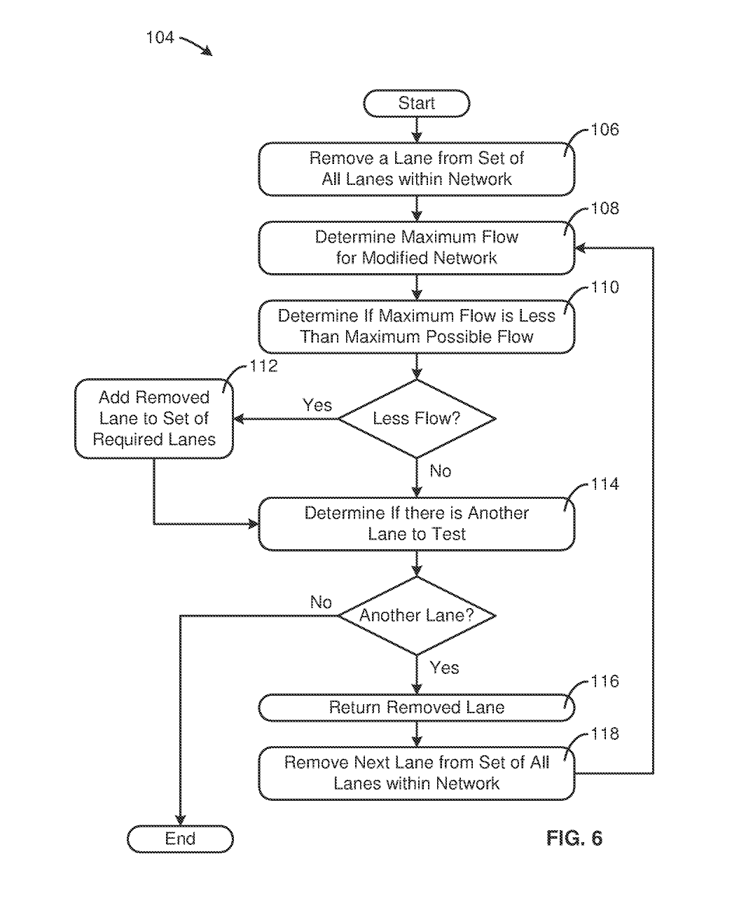

Referring to FIG. 6, once determined 74, a maximum possible flow for a network 10 may be used as a benchmark. For example, in selected embodiments, a maximum possible flow may be used in a method 104 for finding 76 certain required lanes 19. This may be accomplished by removing 106 a lane 19 from a set of all lanes 19 in a computer model of a network 10. The maximum flow for the modified network 10 may then be determined 108. If the maximum flow so determined 108 is less than the maximum possible flow (e.g., the benchmark maximum possible flow), it is an indication that the removed lane 19 may be required to achieve the maximum possible flow. Accordingly, the removed lane 19 may be added 112 to a set of required lanes 19.

Conversely, if the maximum flow so determined 108 is not less than the maximum possible flow, it may be an indication that the removed lane 19 is not required to achieve the maximum possible flow. Accordingly, the removed lane 19 is not added 112 to a set of required lanes 19.

Once the required or non-required nature of one lane 19 has been established, a determination 114 may be made as to whether there is another lane 19 to process or test. If not, the process 104 may end. If one or more lanes 19 remain to be processed or tested, then the one lane 19 may be returned 116 to the computer model of the network 10. The next lane 19 to be processed or tested may then be removed 118 and the process 104 may continue. In this manner, an optimization module 50 or one or more components thereof (e.g., a required lane module 58 operating in conjunction with a flow module 56) may identify a set of required lanes 19 within a network 10.

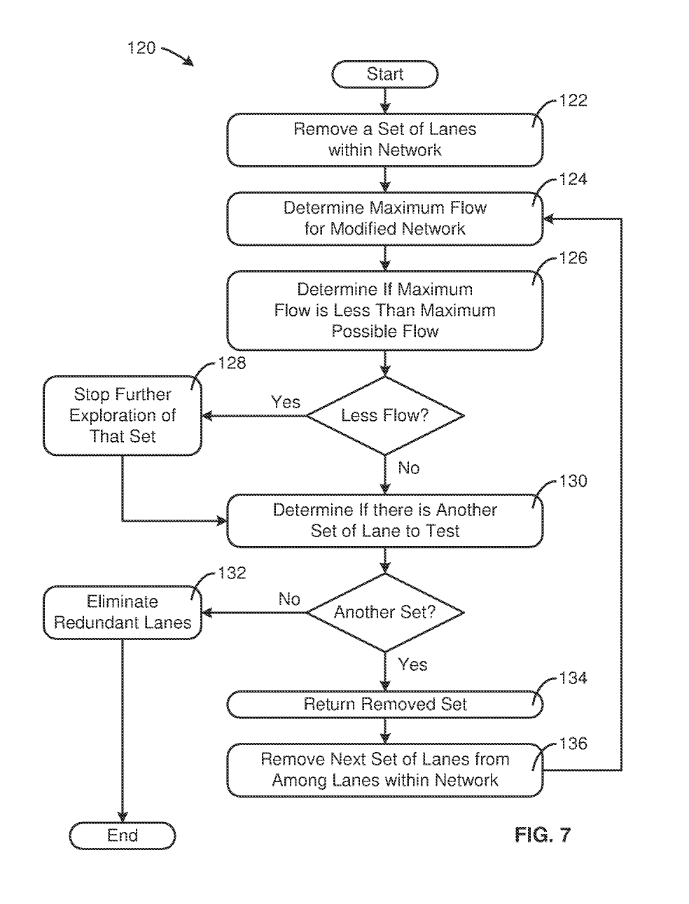

Referring to FIG. 7, a maximum possible flow for a network 10 may also be used as a benchmark in a method 120 for eliminating 78 redundant lanes 19. In selected embodiments, such a method 120 may begin with removal 122 of a set of lanes 19 from a computer model of a network 10. The set of lanes 19 removed 122 may not include any lanes 19 contained within the set of required lanes 19 (i.e., required lanes 19, by definition, are necessary and not redundant). Thus, if a network 10 is found to contain a set of required lanes 19 and a residual collection of lanes 19, the set of lanes 19 to be removed 122 in this process 120 may be selected from the residual collection of lanes 19.

Once an appropriate set of lanes 19 has been removed, the maximum flow for the modified network 10 may then be determined 124. If the maximum flow so determined 124 is less than the maximum possible flow (e.g., the benchmark maximum possible flow), it may be an indication that the removed set of lanes 19 (or some subset thereof) is required to achieve the maximum possible flow. Accordingly, further exploration of that set of lanes 19 may be stopped. Conversely, if the maximum flow so determined 124 is not less than the maximum possible flow, it may be an indication that the removed set of lanes 19 is redundant and not required to achieve the maximum possible flow.

Once the redundant or non-redundant nature of a set of lanes 19 has been established, a determination 130 may be made as to whether there is another set of lanes 19 to process or test. If not, the redundant lanes 19 may be eliminated 132 and the process 120 may end. If one or more sets of lanes 19 remain to be processed or tested, then the set of lanes 19 just processed or tested may be returned 136 to the computer model of the network 10. The next set of lanes 19 to be processed or tested may then be removed 136 and the process 120 may continue.

A process 120 in accordance with the present invention may test every possible combination of lanes 19 that can be derived from the a residual collection of lanes 19 (i.e., the lanes 19 that are not part of the set of required lanes 19). This may be accomplished in any suitable manner. In selected embodiments, an optimization module 50 or one or more components thereof (e.g., a lane redundancy module 60) may follow a predetermined pattern or algorithm in order to ensure that every possible combination of lanes 19 is processed or tested. For example, in certain embodiments, a lane redundancy module 60 may perform a depth-first search or analysis within the residual collection of lanes 19.

The flowcharts in FIGS. 4-7 illustrate the architecture, functionality, and operation of possible implementations of systems, methods, and computer program products according to certain embodiments of the present invention. In this regard, each block in the flowcharts may represent a module, segment, or portion of code, which comprises one or more executable instructions for implementing the specified logical function(s). It will also be noted that each block of the flowchart illustrations, and combinations of blocks in the flowchart illustrations, may be implemented by special purpose hardware-based systems that perform the specified functions or acts, or combinations of special purpose hardware and computer instructions.

It should also be noted that, in some alternative implementations, the functions noted in the blocks may occur out of the order noted in the Figures. In certain embodiments, two blocks shown in succession may, in fact, be executed substantially concurrently, or the blocks may sometimes be executed in the reverse order, depending upon the functionality involved. Alternatively, certain steps or functions may be omitted if not needed.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A method for optimizing a distribution network, the method comprising:
obtaining, by a computer system, first data characterizing supply sites, demand sites, and lanes of a distribution network;
obtaining, by a computer system, second data characterizing supply and demand for an item distributed within the distribution network;
using, by the computer system, the first and second data to
determine a maximum possible flow of the item within the distribution network,
eliminate from within the lanes one or more redundant lanes, and
identify within a set of non-eliminated lanes at least two alternative sets of lanes, each of the at least two alternative sets of lanes achieving the maximum possible flow; and
identifying, by the computer system, which of the at least two alternative sets of lanes has the lower cost associated therewith.

2. The method of claim 1, wherein obtaining the second data comprises obtaining, by the computer system, a plurality of demand quantities, each corresponding to a different demand site of the distribution network and quantifying demand for the item.

3. The method of claim 2, wherein obtaining the second data comprises obtaining, by the computer system, a plurality of supply quantities, each corresponding to a different supply site of the distribution network and quantifying supply of the item.

4. The method of claim 3, wherein determining the maximum possible flow comprises scaling proportionally down, by the computer system, each demand quantity of the plurality of demand quantities to obtain a plurality of scaled demand quantities.

5. The method of claim 4, wherein determining the maximum possible flow further comprises calculating iteratively, by the computer system, a flow for the distribution network using the plurality of supply quantities while progressively scaling up at least certain scaled demand quantity of the plurality of scaled demand quantities.

6. The method of claim 5, wherein determining the maximum possible flow further comprises stopping, by the computer system, the calculating after a stopping condition has been met.

7. The method of claim 6, wherein the calculating comprises determining within each iteration whether any demand site of the distribution network receives less than a demand quantity of the plurality of demand quantities corresponding thereto.

8. The method of claim 7, wherein the calculating further comprises fixing the demand quantity corresponding to a demand site of the distribution network when, in an iteration, the demand site receives less than the demand quantity.

9. The method of claim 8, wherein fixing comprises fixing the demand quantity corresponding to the demand site at an amount received in the iteration.

10. The method of claim 9, wherein the calculating further comprises calculating iteratively, by the computer system, a flow for the distribution network using the plurality of supply quantities while progressively scaling up the scaled demand quantity of the plurality of scaled demand quantities that have not yet been fixed.

11. The method of claim 10, wherein the calculating further comprises determining within each iteration whether a total demand equal to a sum of the plurality of demand quantities has been obtained.

12. The method of claim 11, wherein the stopping condition is met when the total demand has been obtained.

13. The method of claim 10, wherein the calculating further comprises determining within each iteration whether the flow corresponding thereto is the same as the flow corresponding to a previous iteration.

14. The method of claim 13, wherein the stopping condition is met when the flow corresponding an iteration is the same as the flow corresponding to a previous iteration.

15. A method for optimizing a distribution network, the method comprising:
obtaining, by a computer system, first data characterizing supply sites, demand sites, and lanes of a distribution network;
obtaining, by a computer system, second data characterizing supply and demand for an item distributed within the distribution network;
determining, by the computer system using the first and second data, a maximum possible flow of the item within the distribution network;
using, by the computer system, the maximum possible flow as a benchmark in determining which lanes of the distribution network are required to achieve the maximum possible flow; and
using, by the computer system, the maximum possible flow as a benchmark in determining which lanes of the distribution network are redundant lanes.

16. The method of claim 15, further comprising identifying within a set of required, non-eliminated lanes at least two alternative sets of lanes achieving the maximum possible flow.

17. The method of claim 16, further comprising identifying, by the computer system, which of the at least two alternative sets of lanes has the lower cost associated therewith.

18. A computer system comprising:
a plurality of processors;
one or more memory devices operably connected to one or more processors of the plurality of processors; and
the one or more memory devices collectively storing
first data characterizing supply sites, demand sites, and lanes of a distribution network,
second data characterizing supply and demand for an item distributed within the distribution network,
a flow module programmed to use the first and second data in determining a maximum possible flow of the item within the distribution network,
a lane redundancy module programmed to eliminate from within the lanes one or more redundant lanes,
a lowest cost module programmed to identify within a set of non-eliminated lanes at least two alternative sets of lanes, each of the at least two alternative sets of lanes achieving the maximum possible flow, and
the lowest cost module further programmed to identify which of the at least two alternative sets of lanes has the lower cost associated therewith.
